(19) United States
(12) Patent Application Publication
(10) Pub. No.: US 2019/0118142 A1
(43) Pub. Date: Apr. 25, 2019

(54) METHODS, SYSTEMS, AND COMPOSITIONS FOR DELIVERY OF NANOBUBBLES IN WATER TREATMENT SYSTEMS

(71) Applicant: The Regents of The University of California, Oakland, CA (US)

(72) Inventors: James C. Earthman, Irvine, CA (US); Mahendra K. Misra, Carlsbad, CA (US); Stephen D. Slingsby, Costa Mesa, CA (US)

(21) Appl. No.: 16/116,863

(22) Filed: Aug. 29, 2018

Related U.S. Application Data
(60) Provisional application No. 62/551,638, filed on Aug. 29, 2017.

(51) Int. Cl. B01D 61/04; B01D 61/08; B01D 61/02; B01D 65/08; C02F 1/44; C02F 1/52

(52) U.S. Cl. CPC B01D 61/04; B01D 61/08; B01D 61/025; C02F 2101/10; C02F 1/441; C02F 1/52; B01D 65/08

(57) ABSTRACT

Methods, systems, and devices for water treatment or for preventing fouling of components of water treatment systems can include the upstream introduction of nanobubbles in-line and/or in close proximity to a reverse osmosis membrane in the water treatment system. The nanobubbles can bind to and cluster (flocculate) nanoparticles (and possible larger solid particles) so that they can be removed and not foul water purification components such as reverse osmosis membranes. The nanobubbles can also interact with and change some characteristics of nanoparticles and thereby reduce fouling of some system components, such as reverse osmosis membranes, or other components. The systems, methods, and devices disclosed herein can help produce potable water safe for human consumption in a more cost-effective manner, e.g., by reducing maintenance costs and in some cases manufacturing costs.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD OF THE DISCLOSURE

The present inventions relate to production of safe, potable water for human consumption, by way of, for example, but without limitation, water desalination and purification, and to methods, systems, and devices for the introduction of nanobubbles into water (e.g., in a water desalination or purification process), wherein the nanobubbles reduce clogging and fouling of system components, such as reverse osmosis membranes.

### BACKGROUND OF THE INVENTIONS

Water demand globally is projected to increase by 55% between 2000 and 2050 according to the United Nations Global Water Forum. Much of the demand is driven by agriculture, which accounts for 70% of global freshwater use, and food production is projected to grow by 69% by 2035 to feed the growing population. Water withdrawal for energy, used for cooling power stations, is also predicted to go up by over 20%. Thus, the near future will undoubtedly put more stress on existing supplies of fresh water. Desalination and water purification can be used to produce clean fresh water that would be sufficient to meet this ever-increasing need. However, the cost of both desalination and water purification can be prohibitive particularly in developing countries.

For example, fouling of components in desalination and water purification systems (e.g., filters, membranes) affect the frequency of periodic system shutdowns required for either a labor-intensive removal or cleaning of the components or complete component replacement. Currently, continuous dosing of dispersant or anti-scaling chemicals can reduce fouling rates, however the cost of such a solution is quite high. Some known designs for water treatment systems incorporate the technique of injecting bubbles into the water under treatment in order to assist in the capture and floatation of fine particles of suspended matter. For example, FIG. 1A includes an illustration from U.S. Pat. No. 7,632,400 titled Water Treatment Equipment, issued Dec. 15, 2009, and illustrates a water treatment system that incorporates the injection of “micronanobubbles . . . to increase floatation force” of suspended matter within the water. Subsequent to removal of floated matter, the water is fed to a reverse osmosis treatment device.

### SUMMARY OF THE INVENTIONS

An aspect of at least one of the inventions disclosed herein includes the realization that nanobubbles, with their relatively high zeta potential, can bind to and cluster nanoparticles and that could otherwise foul reverse osmosis (RO) membranes used in water purification and desalination systems. Nanobubbles are small bubbles in liquids generally having a diameter of less than one (1) micrometer (a.k.a. “micron” or 1000 nm) and larger than 0.01 microns (or 10 nm).

Zeta potential is an indication of a physical property exhibited by a particle in suspension; a measurement of the magnitude of the electrostatic repulsion or attraction between particles and bubbles. For reference, FIG. 1B is a schematic view of a nanobubble. The zeta potential of nanobubbles in neutral pH water at room temperature generally falls between −30 and −40 mV as a result of ions concentrated on the bubble surface (from Takahashi, M., 2005, Zeta potential of microbubbles in aqueous solutions: electrical properties of the gas-water interface, J. Phys. Chem. B 109:21858-21864).

An aspect of at least one of the inventions disclosed herein includes the discovery that injecting nanobubbles into a reverse osmosis system can extend the time between required maintenance cycles from about two weeks to over five months for water purification; effectively increasing the time required between membrane maintenance treatments by ten-fold.

In some embodiments, a water desalination and/or purification system includes in-line introduction of nanobubbles into flowing water (e.g., as opposed to a large tank system with water that is stagnant, flowing in random directions, large eddys, or not flowing rapidly). As previously discussed, nanobubbles have demonstrated the ability to bind to and cluster nanoparticles that would otherwise foul water purification components (e.g., reverse osmosis membranes) downstream. For example, the nanobubbles can be used to defoul hydrophilic surfaces and cluster nanoparticles in suspension, while reducing the fouling of hydrophilic and hydrophobic surfaces (e.g., removing calcium carbonate deposits from pipe walls, preventing the pitting of pipes by removing the calcium carbonate shell of anaerobic and aerobic bacteria that cause pitting in pipes, etc.). Thus, some embodiments disclosed herein can help reduce maintenance and replacement costs with respect to the production or fresh water via water desalination, purification, etc.

Some embodiments disclosed herein include features methods, systems, and compositions for reducing clogging and fouling of components of water purification systems. Some of the methods, systems, and compositions feature the in-line introduction of nanobubbles, which cluster nanoparticles. The clustered nanoparticles may be generally large enough so as not to clog or foul water purification components such as reverse osmosis membranes.

Some embodiments disclosed herein include a system for purifying water. In some embodiments, the system can comprise a feed pump for pumping water from a raw water tank and a nanobubble generating component fluidly connected to the feed pump. Water from the raw water tank can be pumped via the feed pump through the nanobubble generating component. The nanobubble generating component can generate nanobubbles and introduces the nanobubbles into water therein. The nanobubbles can cluster nanoparticles. The system can further comprise a reverse osmosis (RO) system fluidly connected to the nanobubble generating component. A high pressure pump can pump water from the nanobubble generating component to the RO system, wherein water is treated through a RO membrane in the RO system. In some embodiments, some or all of the clustered nanoparticles are removed in or prior to the RO system. The system may further comprise a product water storage tank fluidly connected to the RO system (or a UV disinfection system) such that water filtered through the RO membrane of the RO system is directed to the product water storage tank.

In some embodiments, the system further comprises a pre-treatment component (e.g., a filter) disposed between the feed pump and the nanobubble generating component. In some embodiments, the filter comprises a conventional media filter, a micron filter, or a combination thereof. In some embodiments, the clustered nanoparticles are removed using a gravity well. In some embodiments, the clustered nanoparticles are removed by skimming a surface of the water. In some embodiments, the system has a 1 m³/h permeate capacity.

Some embodiments disclosed herein are directed to methods of purifying water. In some embodiments, a method comprises introducing nanobubbles to flowing water via an in-line mechanism, wherein the nanobubbles cluster nanoparticles in the flowing water; removing the clustered nanoparticles from the flowing water, yielding pre-treated water; and subjecting the pre-treated water to reverse osmosis (RO). In some embodiments, the method further comprises subjecting the pre-treated water to ultraviolet light (UV) treatment after RO.

Some of the embodiments disclosed herein are directed to methods of reducing or preventing fouling of a reverse osmosis (RO) membrane of a water treatment system. In some embodiments, the method comprises introducing nanobubbles to flowing water in the water treatment system via an in-line device, wherein the nanobubbles are introduced upstream of the RO membrane and the nanobubbles cluster nanoparticles in the flowing water. The clustering of the nanoparticles can make them heavier and less likely to stick to the RO membrane, thereby reducing or preventing fouling of the RO membrane.

Another aspect of at least one of the inventions disclosed herein includes the realization that nanobubbles can be particularly beneficial and effective for preventing accumulation of calcium carbonate (CaCO³) from fouling reverse osmosis membranes due to their ability to neutralize a “stickiness” of CaCO³ particles. Along these lines, CaCO³ is a highly hydrophobic substance. Thus, when in solution with water, CaCO³ tends to stick to anything that is not water. The buildup of CaCO³ in water systems has been a problem since ancient times. Modern plumbing systems are designed to accommodate expected deposits of CaCO3, and other substances, yet remain operable for a predictable service life spans.

However, in the context of reverse osmosis membranes, which include pore sizes on a scale of 0.1-0.5 nanometers, CaCO³ particles can be a particular problem. During normal use, CaCO³ within a water flowing into contact with a reverse osmosis membrane can build up on the retentate side of the membrane, adjacent to the pore openings which generally does not affect performance. However, buildup of CaCO³ adjacent to a pore can eventually grow towards the opening of the pore and begin to occlude the pores, thereby reducing performance i.e. the rate of water flow through the membrane. Along those lines, a single CaCO³ molecule, having a diameter of approximately 0.9 nanometers, is well sized to directly clog a single RO membrane pore. As such, CaCO³ can present a significant driving factor in reducing or limiting the life span or maintenance cycle for reverse osmosis membrane.

An aspect of at least one of the inventions disclosed herein includes the realization that nanobubbles are particularly effective for reducing the negative effects of CaCO³ in reverse osmosis systems. One of the relevant characteristics at work in a nanobubble that affects its reactivity with CaCO³ are the concentration of hydroxide ions (OH⁻). More specifically, OH⁻, a minor constituent of liquid water, tends to accumulate at the surface of gas bubbles in water. It has been found that as a bubble shrinks to a nanobubble scale (e.g., 1000-10 nanometers) OH⁻ tends to accumulate around the surface of the nanobubble, creating a spherical layer of OH⁻ around the spherical surface of the bubble. Because OH⁻ ions are negatively charged equally, they repel each other, but due to the interaction with the gas bubble, remain at the surface of the bubble. Thus, such nanobubbles tend to repel each other. Additionally, the build-up of OH⁻ on the surface of the nanobubbles leaves them in a state that is highly reactive with other nanoparticles, including CaCO3.

An aspect of at least one of the inventions disclosed herein includes the realization that providing additional nanobubbles into the flow of water into a reverse osmosis membrane device captures more CaCO³ through interaction with the nanobubbles which tend to reduce or neutralize the hydrophobic nature of the CaCO³ and thus reduce the rate at which CaCO³ sticks to and builds up on the reverse osmosis membrane equipment. As noted above, in some embodiments, adding nanobubbles into the water flowing into a reverse osmosis membrane device can increase the length of the maintenance cycle of the membrane device by 10-fold.

Another aspect of at least one of the inventions disclosed herein includes the realization that because nanobubbles can disperse in a flow of water, i.e., collapse by way of the gases dissolving back into solution, the effectiveness of nanobubble introduction into a reverse osmosis system can be enhanced by injecting nanobubbles closer to the reverse osmosis membrane device in a reverse osmosis membrane system. For example, in some embodiments, a nanobubble generation device can be disposed in close proximity to (e.g. immediately or nearly immediately upstream from) a reverse osmosis membrane device in a reverse osmosis system. In some embodiments, the reverse osmosis system may have a high pressure pump immediately upstream of the reverse osmosis membrane device and in such embodiments, the nanobubble generator device can be disposed immediately upstream of the high pressure pump. In such an arrangement, the high pressure pump and the reverse osmosis membrane device con be considered as together forming a reverse osmosis membrane device.

Another aspect of at least some of the inventions disclosed herein includes the realization that nanobubbles are more likely to reach a reverse osmosis membrane device if they are injected into the system at a location downstream of any reservoirs in an associated water treatment system. For example, some known water treatment systems, which include reverse osmosis subsystems, include one or more reservoirs, in which an upper surface of liquid water in the reservoir is exposed to a gaseous atmosphere and the water therein, during operation is often stagnant, flows in random directions, large eddys, or is slow moving compared to the velocity in pipes connecting the reservoir with other components such as pumps and reverse osmosis membrane devices. Additionally, the water guided into a reservoir usually loses all of the pressure head provided by any pumps, allowing the water to return to atmospheric pressure. The water can only be removed from the reservoir by pumping or draining. Additionally, a “reservoir”, as that term is used herein, allows for the independent addition of water and removal of water, at different times and/or at different rates. This is because a “reservoir” acts as a flow buffer. This type of equipment may have an influent pipe discharging liquid water into the reservoir and the liquid water can circulate around the reservoir in random directions. Additionally, some larger gas bubbles that may be entrained in the liquid water may tend to float upwardly to the upper surface of the water, where such bubbles would tend to accumulate and/or burst, releasing the gases contained therein into the atmosphere above the level of liquid water. Such a reservoir is not an environment conducive to maintaining nanobubbles in a flow of water. For example, after a nanobubble in a reservoir collides with a suspended nanoparticle, it may become heavier and sink in such a reservoir, missing further opportunities to cluster with additional nanoparticles in downstream parts of the system. It has been found that nanobubbles in water can cluster with multiple nanoparticles, for example, as many as five or more, depending on the size and composition of the nanoparticles.

Thus, an aspect of at least one of the inventions disclosed herein includes the realization that a higher concentration of beneficial nanobubbles can reach a reverse osmosis membrane device where the nanobubble generator or the site of injection of nanobubbles into a flow of water in a water treatment system is downstream of any open reservoir in the treatment system. In some embodiments, a nanobubble generation device can be disposed in-line, for example, connected in-line along pipes carrying water into a reverse osmosis membrane device or a high pressure pump feeding a reverse osmosis membrane device, or other non-reservoir components feeding into, ultimately, a reverse osmosis membrane device.

Any feature or combination of features described herein are included within the scope of the present inventions provided that the features included in any such combination are not mutually inconsistent as will be apparent from the context, this specification, and the knowledge of one of ordinary skill in the art. Additional advantages and aspects of the present invention are apparent in the following detailed description and claims.

In some embodiments, a water treatment system can be provided for treating raw water containing suspended particles including suspended nanoparticles by way of introduction of nanobubbles for interacting with the suspended nanoparticles. The system can include a raw water reservoir configured to contain raw water containing suspended particles of calcium carbonate. A first water line assembly can extend from the raw water reservoir. A nanobubble generator device can comprise a first water inlet connected to the first water line assembly and a water outlet, the nanobubble generator device can be configured to add nanobubbles into water received from the first water line assembly and output water mixed with the added nanobubbles from the water outlet, wherein the nanobubble generator is configured to add a number of nanobubbles into the water such that a concentration of nanobubbles in the water output from the nanobubble generator is approximately equal to at least the concentration of nanoparticles in the water output from the nanobubble generator. A second water line assembly can extend from the water outlet. A high pressure water pump can be disposed along the second water line and can be configured to pump the water mixed with nanobubbles from the nanobubble generator to a higher pressure and output it through a high pressure outlet. A reverse osmosis membrane device can comprise a second water inlet, a reverse osmosis membrane assembly, a retentate outlet and a permeate outlet, the second water inlet being connected to the high pressure outlet with the second water line assembly, the membrane assembly comprising a membrane with pores having a size from 0.01 to 0.05 nanometers. The reverse osmosis membrane device can guide the water mixed with added nanobubbles along the membrane assembly such that some of the water molecules included in the water mixed with added nanobubbles flows through the pores and out through the permeate outlet and the remainder of the water mixed with added nanobubbles is discharged from the reverse osmosis membrane device through the retentate outlet.

In some embodiments, a water treatment system can comprise a nanobubble generator device configured to receive water to be treated, add nanobubbles into the water received, and output water mixed with the added nanobubbles. A filter device can comprise a second water inlet, and a filter device assembly. The nanobubble generator device can be disposed in at least one of in-line with the reverse osmosis membrane device and in close proximity to the reverse osmosis membrane device.

In some embodiments, a method can be provided for treating raw water containing suspended particles including suspended nanoparticles by way of introduction of nanobubbles for interacting with the suspended nanoparticles. The method can comprise collecting raw water in a reservoir, the water including suspended particles of calcium carbonate and other contaminates, filtering some contaminates out of the water, thereby generating filtered water containing at least some nanoparticles of calcium carbonate, and detecting a concentration of at least one nanoparticle in the filtered water. The method can also comprise mixing nanobubbles into the filtered water so as to raise a concentration of nanobubbles in the filtered water to a concentration at least as high as the concentration of the at least one nanoparticles in the filtered water, thereby creating a mixture of filtered water and nanobubbles, pumping the mixture of filtered water and nanobubbles to a reverse osmosis membrane device having a membrane with pores having a size from 0.01 to 0.05 nanometers, and clustering at least some of the nanobubble with at least some of the nanoparticles in the mixture of filtered water and nanobubbles. The method can also comprise permeating some of the water molecules included in the mixture of filtered water and nanobubbles through the pores of the reverse osmosis membrane onto the permeate side of the reverse osmosis membrane, retaining at least some of the water molecules and clustered nanobubbles and nanoparticles included in the mixture of filtered water and nanobubbles on the retentates side of the reverse osmosis membrane, and discharging the retained water molecules and clustered nanobubbles and nanoparticles through a rejection outlet of the reverse osmosis membrane device.

In some embodiments, a method for treating water can comprise mixing nanobubbles into water thereby creating a mixture of water and nanobubbles at a location that is at least one of downstream from any reservoirs and in close proximity to a filter device, and passing some of the water molecules included in the mixture of water and nanobubbles through the pores of the filter device.

In some embodiments, a method for reducing maintenance required for a reverse osmosis water treatment system can comprise introducing nanobubbles to flowing water flowing toward a reverse osmosis membrane device, wherein the nanobubbles are introduced into the flowing water in an amount effective to cluster nanoparticles in the flowing water to form clustered nanoparticles, and contacting the water with clustered nanoparticles with a reverse osmosis (RO) membrane, wherein the nanobubbles are introduced into the flowing water in an amount effective to reduce clogging of the RO membrane.

### BRIEF DESCRIPTION OF THE DRAWINGS

The features and advantages of the present invention will become apparent from a consideration of the following detailed description presented in connection with the accompanying drawings in which:

FIG. 1A is a schematic diagram of a prior art water treatment system.

FIG. 1B is a schematic view of a nanobubble for describing zeta potential. The zeta potential of nanobubbles in neutral pH water at room temperature generally falls between −30 and −40 mV as a result of ions concentrated on the bubble surface (from Takahashi, M., 2005, Zeta potential of microbubbles in aqueous solutions: electrical properties of the gas-water interface, J. Phys. Chem. B 109:21858-21864).

FIG. 1C is a schematic perspective view of a reverse osmosis membrane device including a coiled membrane device inside a housing.

FIG. 1D is an enlarged perspective view of the membrane of FIG. 1C, illustrating water flow along and through the membrane.

FIG. 1E is a further enlarged, partial sectional view of the membrane, illustrating the flow of water molecules flowing through the membrane to the permeate side and contaminant molecules flowing along the membrane and remaining on the retentate side of the membrane.

FIG. 1F is a schematic diagram illustrating relative sizes of the pores of a reverse osmosis membrane and various contaminants removed by the reverse osmosis membrane, not drawn to scale.

FIG. 2 is a schematic view of nanobubbles binding to nanoparticles. The relatively large zeta potential of nanobubbles allows them to bind to nanoparticles. The combination of nanobubbles and nanoparticles can form relatively large clusters that will not foul reverse osmosis (RO) membranes.

FIGS. 3A and 3B are photographs of nanobubbles binding to nanoparticles. Nanobubbles bind to particles in solution, producing clusters that are heavier than individual particles and have a greater settling speed. The images are TEM images of freeze-fracture replicas of water+1% NaCl (a, with nanobubbles; b, without nanobubbles) (from Uchida, T et al., 2011, Transmission electron microscopic observations of nanobubbles and their capture of impurities in wastewater, Nanoscale Research Letters 6:295).

FIG. 4 shows a schematic view of an embodiment of a water purification system.

### DETAILED DESCRIPTION OF THE PREFERRED EMBODIMENT

Following is a list of elements corresponding to a particular element referred to herein:
100 water purification system
110 raw water tank
120 feed pump
125 pre-treatment component
130 nanobubble generating device
140 high pressure pump
150 reverse osmosis (RO)
160 inline UV
170 product water storage tank

The inventions disclosed herein are described in the context of improving the operation of reverse osmosis water treatment systems because they have particular utility in that context. However, the inventions disclosed herein can be used in other contexts as well. As is apparent from the description of the inventions set forth below, a system incorporating any of the inventions disclosed herein can be embodied in a wide variety of forms.

In some embodiments, a water treatment system can include a nanobubble generation device dispose upstream from and in close proximity to a reverse osmosis membrane device. In some embodiments, a water treatment system can include a nanobubble generation device disposed in-line with a reverse osmosis membrane device either downstream from any reservoirs that may be in the system or wherein there are no reservoirs, disposed in close proximity to the reverse osmosis membrane. Further, in some embodiments, a water treatment system can include a nanobubble generation device configured to output a number of nanobubbles sufficient to adjust a ratio of nanobubbles to suspended nanoparticles to at least 1:1 or higher.

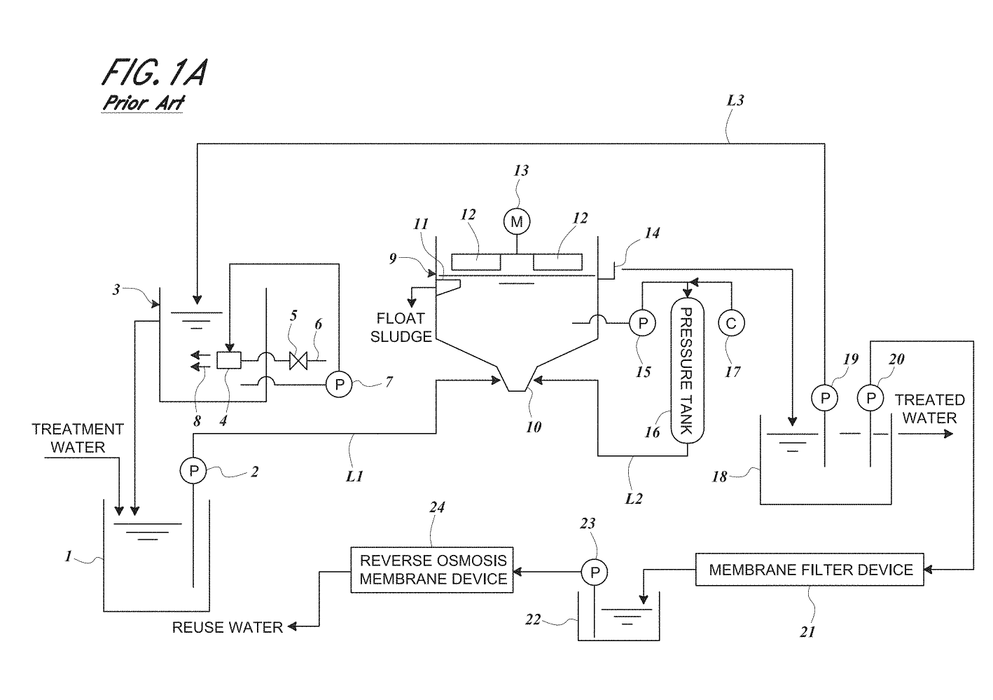

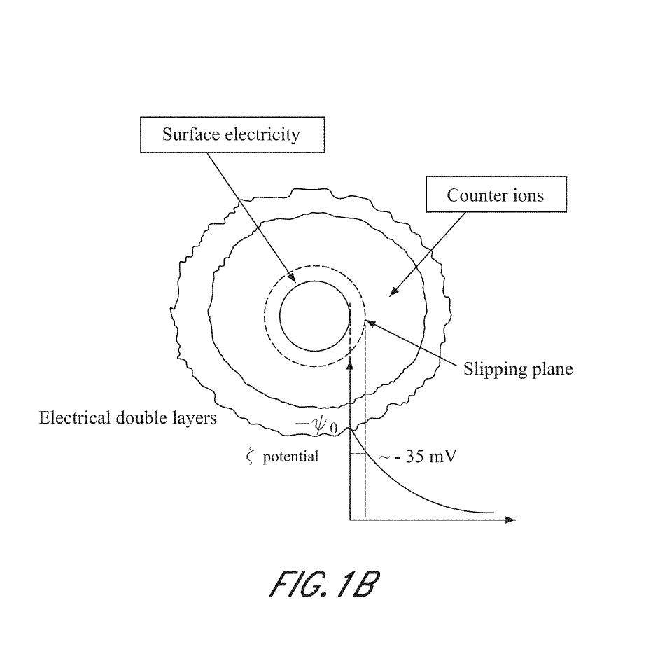

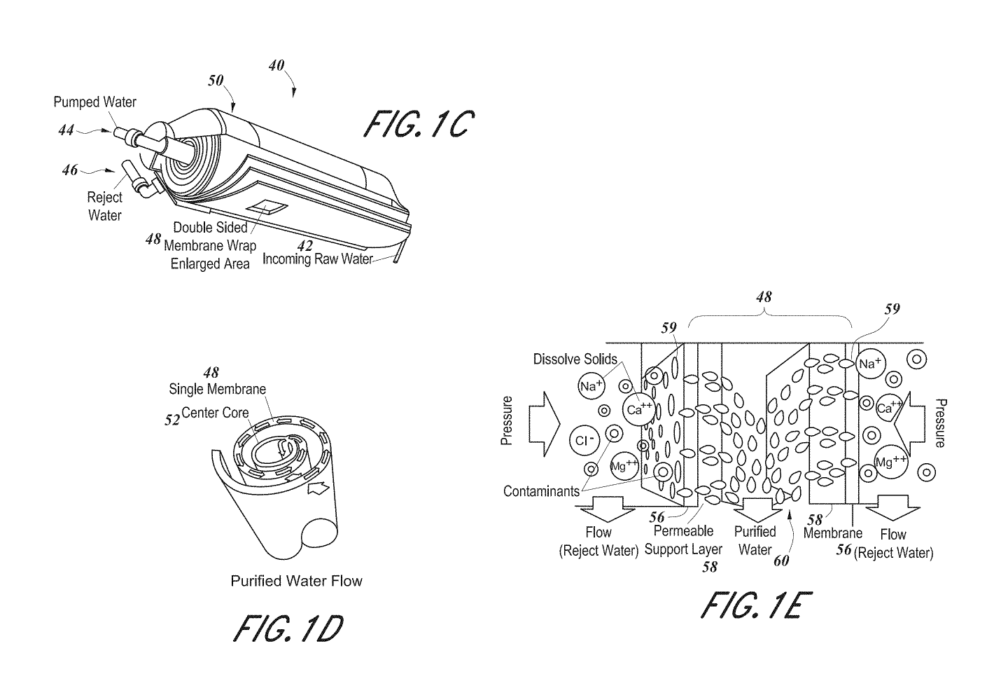

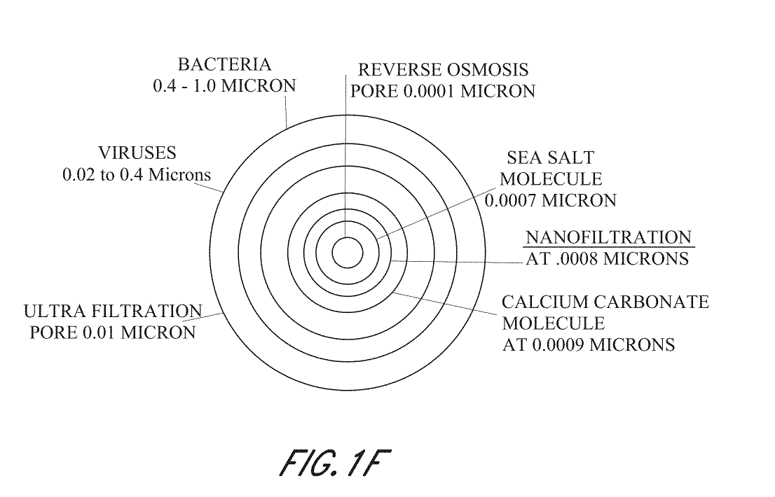

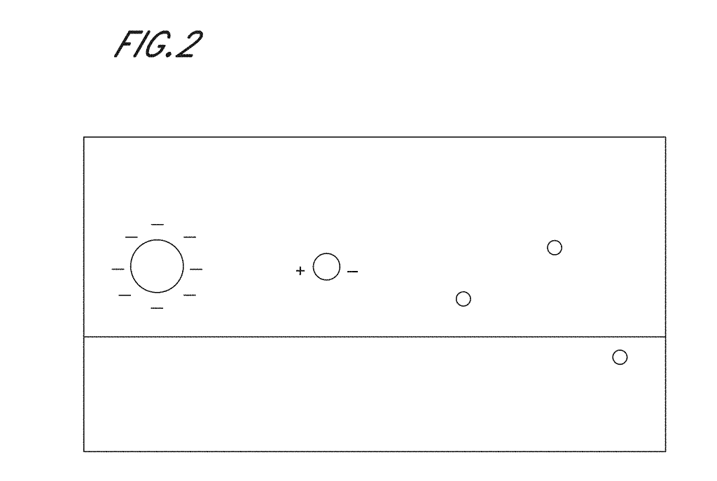

The water treatment system of FIG. 1A incorporates injection of small bubbles into the system upstream from the reverse osmosis equipment, for the purposes of increasing the buoyancy of suspended particles within the water to be treated such that the particles can be floated and removed from the system, upstream from the reverse osmosis equipment.

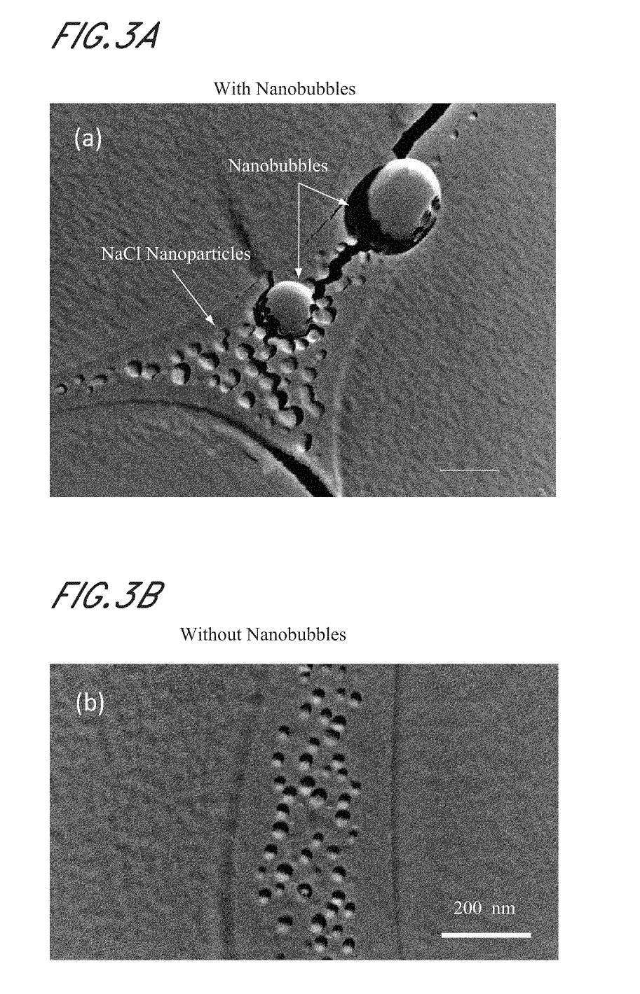

FIG. 1A is taken from FIG. 3 of U.S. Pat. No. 7,632,400. In the illustrated system, influent raw water is introduced into water tank 1. The system also includes an “micronanobubble generation tank” 3, a floatation tank 9, and a treated water tank 18, and reverse osmosis equipment including a membrane filter device 21, a membrane filter device pit 22, and a reverse osmosis membrane device 24.

In this system, water from the raw water tank 1 is pumped, with a pump 2, into a lower mixing section 10 of the floatation tank 9. The water in the raw water tank 10 is also mixed with water from the micronanobubble generation tank 3 which is provided with water from the treated water tank 18 by pump 19 through line L3. Additionally, the water in the generation tank 3 is provided with bubbles by way of micronanobubble generator 4 to create a water stream 8 with bubbles entrained therein. Air is injected into the generator 4 by way of an air suction pipe 6 and a valve 5. Water within the tank 3 is circulated by pump 7. Thus, the water in the raw water tank 1 includes a mixture of raw treatment water as well as water having bubbles entrained therein from the generation tank 3.

The floatation tank 9, in addition to water from the tank 1, is also provided with air pressurized by the compressor 17, and mixed with water from the floatation tank 9 by way of pump 15, through the pressure tank 16 and line L2 into the lower mixing section 10 of the floatation tank 9. Bubbles from both the water flowing in lines L1 and line L2, including both micronanobubbles and fine bubbles are mixed with suspended matter in the water flowing into the floatation tank 9. The U.S. Pat. No. 7,632,400 explains that the fine bubbles provided into the lower mixing portion 10 tend to adhere to the surface of suspended matter therein. The added micronanobubbles are finer and more adhesive than the fine bubbles generated in the floatation device tank 9. As such, both the micronanobubbles and the fine bubbles adhere to suspended matter in “large numbers” and “make it possible to increase the floatation force to the suspended matter.” As such, suspended matter is floated to the top of the floatation tank 9 and are separated out. Treated water from the floatation tank 9 moves to the treated water section 14 and flows into the treated water tank 18. Treated water from the treated water tank 18 is transferred to the membrane filter device by way of pump 20, into the membrane filter device pit 22 and through the reverse osmosis membrane device by way of pump 23.

It is significant to note that the bubbles generated in the system of FIG. 1A, by way of the bubble generation device 4 and the introduction of a mixture of air and water through the pressure tank 16, are injected into multiple reservoirs before reaching the reverse osmosis membrane device 24.

In particular, the bubbles generated by the device 4 are generated in a tank, or in other words, a “reservoir” which has an upper liquid level and an atmosphere thereabove, as illustrated in FIG. 1A. Water from the tank 3 is then mixed into the raw water tank 1, another reservoir having an upper surface of liquid water with an atmosphere thereabove. Both of these reservoirs allow for bubbles, an in particular buoyant bubbles, to float to the top and thus rupture at the surface of the water.

The bubbles that remain in mixture, in the tank 1, are then provided to the mixing section 10 of the flow tank 9, which is yet another reservoir. Those bubbles and the additional bubbles from the pressure tank 16, are then subject yet again to floatation and all of the water drawn into the treated water tank 18 is taken from an upper portion of the float tank identified as the treated water section 14. That water is then pumped into yet another open reservoir 18, filtered through the filter device 21, and into yet another reservoir 22 before being fed into the reverse osmosis membrane device 24.

Thus, the system of FIG. 1A provides both a significant amount of time for any nanobubbles that may be present in any of the water in the illustrated system to decay. Further, the descriptions of the system illustrated in FIG. 1A, set forth in U.S. Pat. No. 7,632,400, describe the use of bubbles as adhering to suspended particles and providing buoyancy thereto. As such, U.S. Pat. No. 7,632,400 suggests that the bubbles described therein are not “nanobubbles” because it is known that nanobubbles are generally not buoyant in liquid water. Rather, nanobubbles, i.e., bubbles having a diameter of approximately 1000-10 nm, are generally neutrally buoyant in liquid water, neither ascending nor descending at a significant speed in water. Nanobubbles are also distinguishable from larger “microbubbles” in terms of visibility to the naked eye. Water entrained with a significant amount of “microbubbles” would appear milky. In contrast, water entrained with a significant amount of nanobubbles appears clear to the naked eye.

FIG. 1C illustrates a prior art reverse osmosis membrane device, providing further context for the use of some of the inventions disclosed herein. The membrane device identified generally by the reference numeral 40 includes an inlet 42, an outlet 44 for treated water, and a reject water outlet 46. In this type of device, the membrane assembly 48 is a large sheet of multilayered material wrapped into a coil and disposed within a housing 50.

With reference to FIG. 1D, the innermost end of the membrane assembly 48 is attached to a center core 52. Water flowing through the membrane assembly 48, enters the center core, and is discharged through the treated water outlet 44. Water and the entrained contaminants that do not pass through the membrane assembly 48, are discharged through the reject water outlet 46.

Thus, in a reverse osmosis membrane device, not all of the liquid water to be treated passes through the membrane assembly 48. Rather, the water is directed to flow along the membrane assembly 48 while some of the water passes through the membrane assembly, at a generally slow flow rate through the pores 59 of the membrane assembly 48. Even in systems with pressure pumps, this remains the primary principle of operation of a reverse osmosis membrane device; not all of the water entering the device passes through the membrane pores. Rather, a significant amount of the water entering the device is discharged along with contaminants that do not pass through the pores 59 of the membrane assembly 48. Thus, the reverse osmosis principle of operation is described as using pressure to drive a solvent from a region of high solute concentration through a semipermeable membrane to a region of low solute concentration by applying a pressure in excess of the osmotic pressure.

Membranes used for reverse osmosis typically have a dense layer in the polymer matrix—either the skin of an asymmetric membrane or a polymerized layer within a thin film composite membrane—where the separation occurs. In most cases, the membrane is designed to allow only water molecules (appx 0.3 nm) to pass through this dense layer while preventing the passage of solutes (such as salt ions). This process requires high pressure to be exerted on the high concentration side of the membrane, usually 30 to 250 psi fresh and brackish water and 600 to 1,200 psi for sea water, which has around a 390 psi natural osmotic pressure that must be overcome. Oftentimes, an entire water treatment system incorporating a reverse osmosis membrane device, such as the device 40 illustrated in FIG. 1C, would include a sediment filter to trap particles, including rust and some CaCO³, optionally a second sediment filter with smaller pores, an activated carbon filter to trap organic chemicals and chlorine which tend to attack and degrade thin film composite membrane reverse osmosis membranes, a reverse osmosis filter, which is usually a thin film composite membrane, optionally, a second carbon filter to capture those chemicals not removed by the reverse osmosis membrane, and optionally an ultraviolet lamp for sterilizing any microbes that may escape filtering by the reverse osmosis membrane. Many different variations of this general arrangement exist.

FIG. 1E schematically illustrates the flow of water and contaminants along and through a membrane assembly 48. As shown in FIG. 1E, the membrane assembly 48 includes a membrane layer 56 and a permeable support layer 58. The membrane layer 56 can include pores 59 having sizes of about 0.0001 microns to 0.0005 microns. In the illustrated membrane assembly 48, there are two membrane layers 56 on the outer sides of the assembly 48, two semipermeable support layers 58 immediately inside of the membranes 56, and a purified water passage 60, in the center.

As the raw water flows along the outer surface of the membrane layers 56, water molecules pass through the reverse osmosis pores 59, but nearly all other contaminants, being much larger than the reverse osmosis pores 59, continue to flow along the outer surface of the membrane 56. The flow of water through the pores 59 in the membranes 56 can be quite slow which prevents contaminants, such as dissolved solids which often include salts (identified as Na+) calcium (identified as Ca++), chlorine (identified as Cl−) and magnesium (identified as Mg++). The low flow rates of the water molecules through the pores 59 of the membrane layers 56 prevents the larger dissolved solids from being pressed onto the openings of the pores 59 and preventing flow therethrough.

FIG. 1F is a schematic diagram illustrating the relative sizes, (not to scale) of various dissolved solids relative to the size of the pores in a reverse osmosis membrane. In FIG. 1F, the reverse osmosis membrane pore 59 is in the center, and can be considered as having a diameter of approximately 0.0001-0.0005 microns. Six other types of dissolved solids sizes are also illustrated in FIG. 1F, including sea salt having a diameter of approximately 0.0007 microns, calcium carbonate molecules are illustrated as having a diameter of about 0.0009 microns, viruses are illustrated as having diameters of approximately 0.02 to 0.4 microns, and bacteria are illustrated as having diameters of approximately 0.4-1.0 microns. For comparison, an ultrafiltration pore size is illustrated as having a diameter of approximately 0.01 microns and a typical nanofiltration pore size of about 0.0008 microns.

One of the driving factors controlling the maintenance cycle and life span of reverse osmosis membranes is fouling with contaminants. One of the contaminants that fouls reverse osmosis membranes at a high rate is CaCO³. CaCO³ is a highly hydrophobic substance. Thus, when in solution, CaCO³ tends to move toward and make contact with anything that is not water. Thus, in the environment of a reverse osmosis membrane device, CaCO³ can come into contact with the interior of the housing 50 as well as the membrane layer 56. When CaCO³ comes into contact with non-water surfaces, it tends to stick to such surfaces.

An aspect of at least one of the inventions disclosed herein includes the realization that nanobubbles can significantly reduce or neutralize the “stickiness” of CaCO³ molecules in solution. For example, nanobubbles tend to be characterized by an outer layer of hydroxide ions (OH⁻), which react readily with CaCO³, and thereby become less hydrophobic and thus less sticky when in solution and clustered with a nanobubble.

Thus, in some embodiments, a water treatment system including a reverse osmosis membrane device, is provided with an increased concentration of nanobubbles in the vicinity of the reverse osmosis membrane device. In some embodiments, the addition of nanobubbles as such helps reduce fouling of the membrane device with CaCO³, by way of the mechanism of partial or complete neutralization of the hydrophobic nature of CaCO³ by way of clustering with nanobubbles therein.

Thus, in some embodiments, water purification systems can include introduction of nanobubbles to bind to and cluster nanoparticles that would otherwise foul water purification components (e.g., reverse osmosis membranes, etc.) downstream (see FIG. 2 and FIG. 3, which show a schematic view and TEM images, respectively, of nanobubbles binding to nanoparticles).

For example, the nanobubbles can be directly injected into flowing liquid upstream of the components that would otherwise be fouled by nanoparticles in the water. The nanobubbles bind to and cluster (flocculate) nanoparticles (and possible larger solid particles) in the water. These clustered nanoparticles are too large to become lodged in the small pores of certain downstream devices such as a reverse osmosis (RO) membrane. These clustered nanoparticles can be easily removed and not foul purification componentry further downstream. The systems, methods, and devices disclosed herein can help produce potable water safe for human consumption in a more cost-effective manner, e.g., by reducing maintenance costs and in some cases manufacturing costs (e.g., by enabling industries to recycle and reuse water). The systems, methods, and devices disclosed herein can be used in a variety of industries (not limited to water purification for direct human consumption), e.g., food processing plants where purified water is required.

Nanobubbles can be generated in-line using a variety of methods, such as but not limited to methods well known to one of ordinary skill in the art. Gurung et al., 2016, Geosystem Engineering 19:133-142 describes a few traditional methods for generating nanobubble such as cavitation, ultrasonication, electrolysis, a Venturi-type generator, etc. In some embodiments, the nanobubble generating device 130 described below can be in the form of a turbo mixer, such as those commercially available from Nikuni, commercially available as the Karyu Turbo Mixer. The Karyu Turbo Mixer includes a motor powered turbine that draws in raw water and gas and outputs a flow of water with micro and nanobubbles entrained therein. Such a device, as well as others, can generate nanobubbles in a controlled fashion and do not require dumping of the output into an open reservoir that is necessary for some other types of bubble generation devices. Rather, this type of nanobubble generating device can be installed in-line so as to provide a continuous output for feeding into the high pressure pump 140 and the reverse osmosis membrane device 150. Additionally, the Nikuni type turbo mixers can also inject any type of gas into the water flow, including atmospheric air, oxygen, or any gas.

Thus, in some embodiments, a water treatment system can include a pump used to pretreat the water containing impurities (e.g., sodium chloride, calcium carbonate, other compounds). Nanoparticles or possibly larger particles made up of the aforementioned compounds are bound to and then removed from the water using a device such as a reject line, filter or trap.

Microbubbles, which are larger than nanobubbles, have demonstrated the ability to induce flocculation, where the microbubbles collect on a larger particle, forming a floc that is less dense than water. This floc then rises due to buoyancy. The microbubbles can cluster around particles of oil or solids.

Nanobubble flocculation was compared with conventional coagulation treatment of chemical mechanical polishing wastewater from a semiconductor production facility. In this case, the nanobubble flocculation method in coordination with coagulation was found to be more cost effective than conventional coagulation techniques. The nanobubbles cluster around the particulates and can be removed using a gravity well or by skimming the surface of the solution depending on the buoyancy of the flocculation.

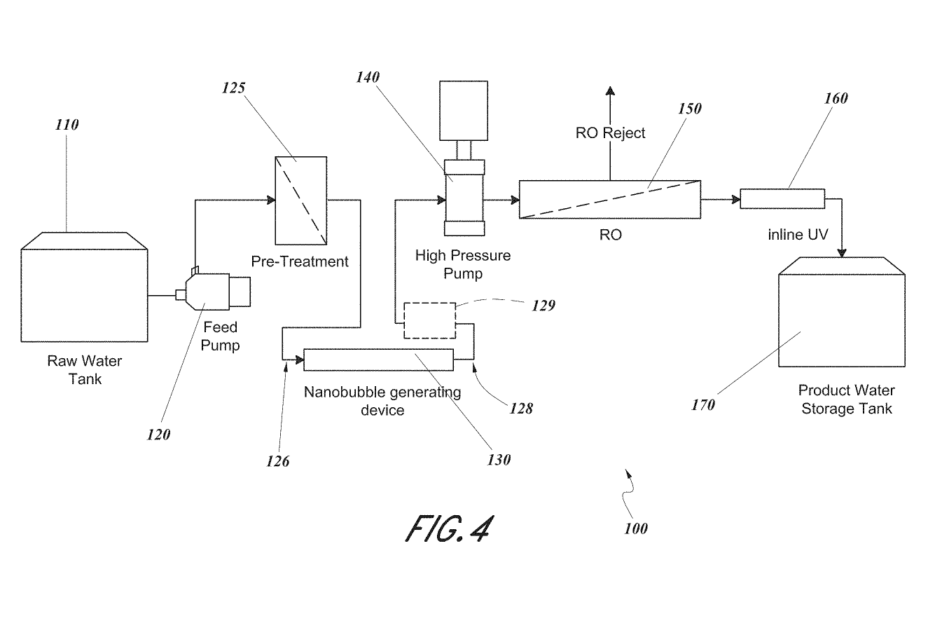

With reference to FIG. 4, the system 100 can comprise a feed pump 120 that pumps water from the raw water tank 110, which can be considered a “reservoir,” to a pre-treatment component 125. In some embodiments, the pre-treatment component 125 can comprise conventional media filters and/or micron filters. The system can further comprise a nanobubble generating device 130 configured to output nanobubbles into water flowing through the system toward the filter device 150, which can be in the form of a fine filter, ultra fine filter, or a reverse osmosis (RO) device 150. Thus, the filter device can include a filter element having pores from 0.01 nm up to 500 nm. In the embodiments in which the filter device is an RO device, the filter element can be in the form of a reverse osmosis membrane having pore sizes between 0.01-0.05 nm. Optionally, a high pressure pump 140 can be configured to pump water from the nanobubble generating device 130 to the reverse osmosis (RO) device 150, which includes a reverse osmosis membrane disposed therein. Downstream from the RO device 150, system 1000 can include a UV disinfection system 160, through which the permeate water can be passed and then into a treated water storage tank 170. Other configurations of the water treatment system 100 can also be used.

As noted above, by providing nanobubbles into the system 100 in proximity to the reverse osmosis membrane device 150, the nanobubbles so provided can provide one or more benefits, including clustering with nanoparticles flowing in the water that reaches the reverse osmosis membrane device 150, as well as reducing certain characteristics or affecting certain characteristics of some contaminants.

For example, as noted above, nanobubbles can have the effect of reducing the hydrophobic nature and thus the “stickiness” of CaCO³. As such, it has been found that such an addition of nanobubbles in proximity to a reverse osmosis membrane device 150 and/or in-line with a reverse osmosis membrane device 150, can provide a significant enhancement to the reduction in operation costs of such a system. Additionally, CaCO³ in other nanoparticles clustered with nanobubbles (bound to nanobubbles) can be removed with the RO reject. In some embodiments, the system 100 can be sized so as to have a 1 m3/h permeate output capacity.

Various parameters may be monitored, for example pressures (feed and reject, derived pressure drop across the membranes), flow (feed, reject, permeate and reject recirculation), feed and permeate electrical conductivities, and permeate pH.

As discussed above, it was surprisingly found that as a result of nanobubble treatments, membrane maintenance extended from about two weeks to over five months for water purification, an approximate ten-fold improvement of the duration of performance between maintenance cycles. Further, scaling was negligible as evidenced by no change in feed pressures and pressure drop across RO membranes, permeate flow rates, and permeate electrical conductivities.

As previously discussed, in some embodiments, a water system can include in-line generation of nanobubbles which can be combined with additional water purification technologies (e.g., RO) where the nanobubbles are implemented to cluster nanoparticles that otherwise would foul the additional purification technology used.

The disclosures of the following U.S. patents are incorporated in their entirety by reference herein: U.S. Pat. Nos. 7,632,400; 7,803,272; 7,914,677.

In some embodiments, the nanobubble generating device 150 can be sized and/or configured and powered to produce a number of nanobubbles sufficient to raise a concentration of nanobubbles in the water flowing therethrough to be effective in extending the life cycle or maintenance cycle of the membrane within the reverse osmosis membrane device 150.

For example, a sample can be taken from the system at point 126, upstream from the nanobubble generating device 130. The sample can be analyzed to determine sizes, compositions, and concentrations of nanoparticles and nanobubbles in the water. The nanobubble generating device 130 can be configured to output a number of nanoparticles sufficient to increase the concentration of nanobubbles in the water flowing therethrough to be approximately the same as the concentration of nanoparticles in the water detected at point 126. To calibrate such a device, a sample can be taken from point 128 in the system 100 (FIG. 4) to determine if the amount of nanobubbles output by the nanobubble generating device is sufficient to raise the concentration of nanobubbles in the water flowing therethrough to be equal or greater than the concentration of nanoparticles.

By way of analysis of photographs, such as those illustrated in FIGS. 3A and 3B, a single nanobubble can be capable of clustering with five nanoparticles. However, in the context of a system, such as the system 100 illustrated in FIG. 4, even if the flow of water into the reverse osmosis membrane device 150 includes a 1:1 concentration of nanobubbles and nanoparticles, there may not be sufficient time for all the nanoparticles to collide with or come into sufficiently close proximity to a nanobubble to cluster. Thus, it has been found that effective increases of the service life or maintenance cycle for reverse osmosis membranes can be significantly increased by providing a 1:1 or greater ratio of nanobubbles and nanoparticles in the system. For example, the ratios used can be 2:1 nanobubbles to nanoparticles, 3:1, 4:1, 5:1, 6:1, 7:1, 8:1, 9:1, 10:1, or higher.

Unexpectedly, it was found that by providing a 10:1 ratio of nanobubbles to nanoparticles in the system 100, in the water flowing from the nanobubble generating device 130 to the reverse osmosis membrane device 150 allowed for a ten-fold increase in the required maintenance cycle of the reverse osmosis membrane within the device 150. In other words, the system 100 could be operated without the need to service the membrane for over 20 weeks; a greater than ten-fold increase in operation over the normal period of operation of two weeks.

Samples taken from point 126 and point 128 of the system 100 described above can be analyzed using many known commercially available devices. For example, Malvern Panalytical sells and leases a variety of different devices that can be used, operating on the dynamic light scattering (DLS) principle for determining the sizes, compositions, and concentrations of nanobubbles and nanoparticles in typical water samples. One such model is known as the NS300, other devices can also be used.

Optionally, the system 100 can include a gravity well 129 or catchment. The gracity well can be constructed in accordance with design well known in the art. In some embodiments, the gravity well 129 is configured to allow heavier, clustered nanoparticles and nanobubbles to fall out of the flow of water from the nanobubble generating device 130, into a lower portion of the gravity well 129, which can include an opening that allows it to be cleaned, as desired. Devices such as gravity wells and catchments are not “reservoirs” as that term is used herein because gravity wells and the catchments contemplated herein do not release all or substantially all of the pumping pressure head from upstream pumps, nor do they include a free upper surface of water with a gaseous atmosphere thereabove, nor do they serve a s a flow buffer allowing water to be added or withdrawn independently, and different times and/or at different rates. Rather, gravity wells and other catchments contemplated herein include an enlarged cross section flow area compared to the pipes leaning into and out therefrom, but are closed and maintain all or substantially all of the pressure head of the water flow therethrough, losing head only due to resistance head associate with turbulence or other losses resulting from the flow through the device.

In some embodiments of the system 100, the reverse osmosis device 150 can be replaced with a fine or ultrafine filter. Such filters can have pores up to 500 nm in diameter. An aspect of at least one of the inventions disclosed herein includes the realization that clustering nanoparticles with nanobubbles can also have an unexpectedly significant effect in preventing fouling fine and ultra fine filters. This is because during normal use, fine and ultra fine filters can eventually become fouled with nanoparticles that become lodged within the pores of the filter. Once lodged in such pores, the nanoparticles cannot be easily removed (e.g., by back-flushing or cleaning). However, by adding nanobubbles into water flowing toward a fine or ultra fine filter can cause clustering, as described above, to the extent that clustered nanobubbles and nanoparticles grow to sizes significantly larger than 500 nm, and thus are unable to become lodged into the pores of fine or ultra fine filters. Additionally, as described above, as nanobubbles cluster and/or interact with some common nanoparticles, such as calcium carbonate, thereby reducing the fouling of such filters and allowing them to be reused after back flushing or other types of restorative maintenance.

Various modifications of the inventions, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiments of the present inventions, it will be readily apparent to those skilled in the art that modifications may be made thereto which do not exceed the scope of the appended claims. Reference numbers recited in the claims are exemplary and for ease of review by the patent office only, and are not limiting in any way. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

The reference numbers recited in the below claims are solely for ease of examination of this patent application, and are exemplary, and are not intended in any way to limit the scope of the claims to the particular features having the corresponding reference numbers in the drawings.

1.-12. (canceled)

13. A water treatment system for treating raw water containing suspended particles including suspended nanoparticles by way of introduction of nanobubbles for interacting with the suspended nanoparticles, the system comprising:
a raw water reservoir configured to contain raw water containing suspended particles of calcium carbonate;
a first water line assembly extending from the raw water reservoir;
a nanobubble generator device comprising a first water inlet connected to the first water line assembly and a water outlet, the nanobubble generator device configured to add nanobubbles into water received from the first water line assembly and output water mixed with the added nanobubbles from the water outlet, wherein the nanobubble generator is configured to add a number of nanobubbles into the water such that a concentration of nanobubbles in the water output from the nanobubble generator is approximately equal to at least a concentration of nanoparticles in the water output from the nanobubble generator;
a second water line assembly extending from the water outlet;
a high pressure water pump disposed along the second water line and configured to pump the water mixed with nanobubbles from the nanobubble generator to a higher pressure and output it through a high pressure outlet;
a reverse osmosis membrane device comprising a second water inlet, a reverse osmosis membrane assembly, a retentate outlet and a permeate outlet, the second water inlet being connected to the high pressure outlet with the second water line assembly, the membrane assembly comprising a membrane with pores having a size from 0.01 to 0.05 nanometers;
wherein the reverse osmosis membrane device guides the water mixed with added nanobubbles along the membrane assembly such that some water molecules included in the water mixed with added nanobubbles flows through the pores and out through the permeate outlet and a remainder of the water mixed with added nanobubbles is discharged from the reverse osmosis membrane device through the retentate outlet.

14. The system of claim 13 further comprising a pre-treatment filter disposed between the high pressure pump and the nanobubble generator.

15. The system of claim 13, additionally comprising a gravity well connected to the second water line assembly, between the nanobubble generator and the reverse osmosis membrane device and configured to remove at least some nanoparticles clustered with nanobubbles.

16. The system of claim 13, wherein the nanobubble generator is configured to add a quantity of nanobubbles into the water such that a concentration of nanobubbles in the water output from the nanobubble generator is greater than the concentration of nanoparticles in the water output from the nanobubble generator.

17. The system of claim 13, wherein the nanobubble generator is configured to add a quantity of nanobubbles into the water such that a concentration of nanobubbles in the water output from the nanobubble generator device at least 5 times greater than the concentration of nanoparticles in the water output from the nanobubble generator.

18. The system of claim 13, wherein the nanobubble generator is configured to add a quantity of nanobubbles into the water such that a concentration of nanobubbles in the water output from the nanobubble generator device at least 10 times greater than the concentration of nanoparticles in the water output from the nanobubble generator.

19. The system of claim 13, wherein there are no reservoirs disposed between the nanobubble generator and the reverse osmosis membrane device.

20. The system of claim 13, wherein the nanobubble generator is disposed in close proximity to the reverse osmosis membrane device.

21. The system of claim 13, wherein the nanobubble generator device comprises a gas inlet and a turbo pump configured to inject a gas from input into the gas inlet into water flowing through the turbo pump.

22. A water treatment system, comprising:
a nanobubble generator device configured to receive water to be treated, add nanobubbles into the water received, and output water mixed with the added nanobubbles; and
a filter device comprising a second water inlet, a filter element, and a filter device outlet;
wherein the nanobubble generator device is disposed in at least one of in-line with the filter device and in close proximity to the filter device.

23. The system of claim 22 additionally comprising a raw water reservoir configured to contain raw water containing suspended particles of calcium carbonate and a first water line assembly connecting the nanobubble generator to the raw water reservoir.

24. The system of claim 22, wherein the nanobubble generator is configured to add a number of nanobubbles into the water such that a concentration of nanobubbles in the water output from the nanobubble generator is approximately equal to at least the concentration of nanoparticles in the water output from the nanobubble generator.

25. The system of claim 22 additionally comprising a high pressure water pump configured to pump the water mixed with nanobubbles from the nanobubble generator to a higher pressure and output it to the filter device.

26. The system of claim 25 further comprising a pre-treatment filter disposed between the high pressure pump and the nanobubble generator device.

27. The system of claim 22, wherein the filter element comprises a reverse osmosis membrane assembly comprising a membrane with pores having a size from 0.01 to 500 0.05 nanometers.

28. The system of claim 27, wherein the reverse osmosis membrane device guides the water mixed with added nanobubbles along the membrane assembly such that some of the water molecules included in the water mixed with added nanobubbles flows through the pores and out through the permeate outlet and the remainder of the water mixed with added nanobubbles is discharged from the reverse osmosis membrane device through the retentate outlet.

29. The system of claim 22, additionally comprising a gravity well connected between the nanobubble generator and the filter device and configured to remove at least some nanoparticles clustered with nanobubbles.

30. The system of claim 22, wherein the nanobubble generator is configured to add a quantity of nanobubbles into the water such that a concentration of nanobubbles in the water output from the nanobubble generator is greater than the concentration of nanoparticles in the water output from the nanobubble generator.

31. The system of claim 22, wherein the nanobubble generator is configured to add a quantity of nanobubbles into the water such that a concentration of nanobubbles in the water output from the nanobubble generator at least 5 times greater than the concentration of nanoparticles in the water output from the nanobubble generator.

32. The system of claim 22, wherein the nanobubble generator is configured to add a quantity of nanobubbles into the water such that a concentration of nanobubbles in the water output from the nanobubble generator at least 10 times greater than the concentration of nanoparticles in the water output from the nanobubble generator.

33.-60. (canceled)
